(19) United States
(12) Patent Application Publication
(10) Pub. No.: US 2019/0322419 A1
(43) Pub. Date: Oct. 24, 2019

(54) PACKING BOX

(71) Applicant: MiaSole Photovoltaic Technology Co., Ltd., Beijing (CN)

(72) Inventors: Dongdong Shen, Beijing (CN); Xiaoxue Cheng, Beijing (CN); Lei Shi, Beijing (CN); Junfang Zhang, Beijing (CN); Junying Zheng, Beijing (CN)

(21) Appl. No.: 16/144,577

(22) Filed: Sep. 27, 2018

(30) Foreign Application Priority Data
Apr. 23, 2018 (CN) 201810367385.3
Apr. 23, 2018 (CN) 201810367402.3

(51) Int. Cl. B65D 25/02; G08B 13/14; H02S 40/38; G01S 19/16

(52) U.S. Cl. CPC B65D 25/02; G08B 13/1472; B65D 2211/00; G01S 19/16; H02S 40/38

(57) ABSTRACT

The present disclosure provides a packing box, which includes: a box body; a solar cell module in the box body; a battery in the box body; a function module in the box body; and a solar controller. The solar controller is connected with the solar cell module, the battery and the function module, respectively, and is used to output electrical energy converted by the solar cell module to the battery and control the battery to supply power to the function module. The box body includes a case body with an end provided with an opening, and a box cover that covers and seals the opening. The box cover includes a power generation cover and a protection cover. The protection cover is located at an outside of the power generation cover and is transparent. The solar cell module is disposed at the power generation cover.

### CROSS-REFERENCE TO RELATED APPLICATION

This application is based on and claims priority of Chinese Patent Application No. 201810367385.3, filed on Apr. 23, 2018, and further claims priority of Chinese Patent Application No. 201810367402.3, filed on Apr. 23, 2018, which are incorporated herein by reference in its entirety.

### TECHNICAL FIELD

The present disclosure relates to the field of packaging and transportation technology, and in particular to a packing box.

### BACKGROUND

With the rapid development of e-commerce, demand for express cartons is getting stronger and stronger. However, extensive use of traditional cartons not only causes great waste of resources, but also goes against environmental protection. Thus, a reusable environment-friendly express packaging has become an object of the e-commerce and logistics industry.

### SUMMARY

The present disclosure provides a packing box, which includes: a box body; a solar cell module; a battery disposed on the box body; a function module disposed on the box body; and a solar controller. The solar controller is connected with the solar cell module, the battery and the function module, respectively, and is used to output electrical energy converted by the solar cell module to the battery and control the battery to supply power to the function module. The box body comprises a case body with an end provided with an opening, and a box cover that covers and seals the opening. The box cover includes a power generation cover and a protection cover. The protection cover is located at an outside of the power generation cover and is transparent. The solar cell module is disposed at the power generation cover.

### BRIEF DESCRIPTION OF THE DRAWINGS

A brief introduction will be given hereinafter to the accompanying drawings which will be used in the description of the embodiments in order to explain the embodiments of the present disclosure more clearly. Apparently, the drawings in the description below are merely for illustrating some embodiments of the present disclosure. Those skilled in the art may obtain other drawings according to these drawings without paying any creative labor.

FIG. 1 is a schematic diagram of a packing box according to an embodiment of the present disclosure, viewing from one aspect;

FIG. 2 is a schematic diagram of the packing box according to an embodiment of the present disclosure, viewing from another aspect;

FIG. 3 is a perspective of the packing box according to an embodiment of the present disclosure;

FIG. 4 is a schematic diagram of a packing box according to some embodiments of the present disclosure;

FIG. 5 is a control principle diagram of the packing box according to some embodiments of the present disclosure; and

FIG. 6 is a schematic diagram of the packing box according to some embodiments of the present disclosure, viewing from another aspect.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise indicated. The following description of exemplary embodiments is merely used to illustrate the present disclosure and is not to be construed as limiting the present disclosure.

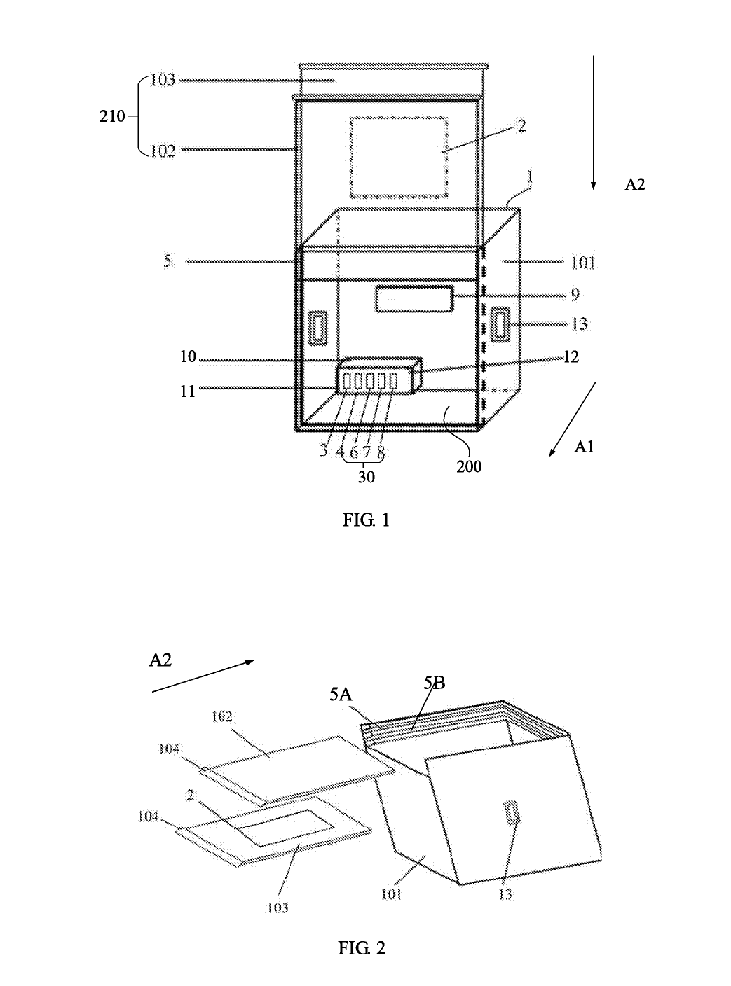

Referring to FIG. 1 to FIG. 3, one embodiment of the present disclosure provides a packing box including a box body 1, a solar cell module 2, a battery 3, a function module 30 and a solar controller 4. The solar cell module 2 and the battery 3 are disposed on the box body 1. The solar controller 4 is connected with the solar cell module 2, the battery 3 and the function module 30, respectively, and is used to output electrical energy converted by the solar cell module 2 to the battery 3 and control the battery 3 to supply power to the function module 30.

The box body 1 includes a case body 101 with an end provided with an opening 200, and a box cover 210 that covers and seals the opening 200. The box cover 210 includes a first cover portion such as a power generation cover 103 and at least one second cover portion such as a protection cover 102. The protection cover 102 is located at an outside of the power generation cover 103 and is transparent. The solar cell module 2 is disposed at the power generation cover 103. Specifically, in one embodiment, when the box body 1 is in a position shown in FIG. 1, relative to an inside of the box body 1, the protection cover 102 is closer to an outside than the power generation cover 103. In other words, in a direction indicated by an arrow A1 shown in FIG. 1, the protection cover 102 is far away from the battery 3 relative to the power generation cover 103.

It should be noted that the quantity of the protection cover 102 may be one or more, and the protection cover 102 is mainly used to protect the power generation cover 103.

The battery 3 is disposed at the box body 1. For example, the battery 3 may be disposed on the box body 1 or within the box body 1. The function module 30 is disposed on the box body 1. The solar controller 4 is connected with the solar cell module 2, the battery 3 and the function module 30, respectively, and is used to output electrical energy converted by the solar cell module 2 to the battery 3 and control the battery 3 to supply power to the function module 30.

As can be understood by those skilled in the art that, the function module 30 may include an anti-theft module 6, a global positioning system (GPS) module 7 and a general packet radio service (GPRS) module 8. The function module 30 may also include some light emitting devices, sounding devices, etc., which are not further defined.

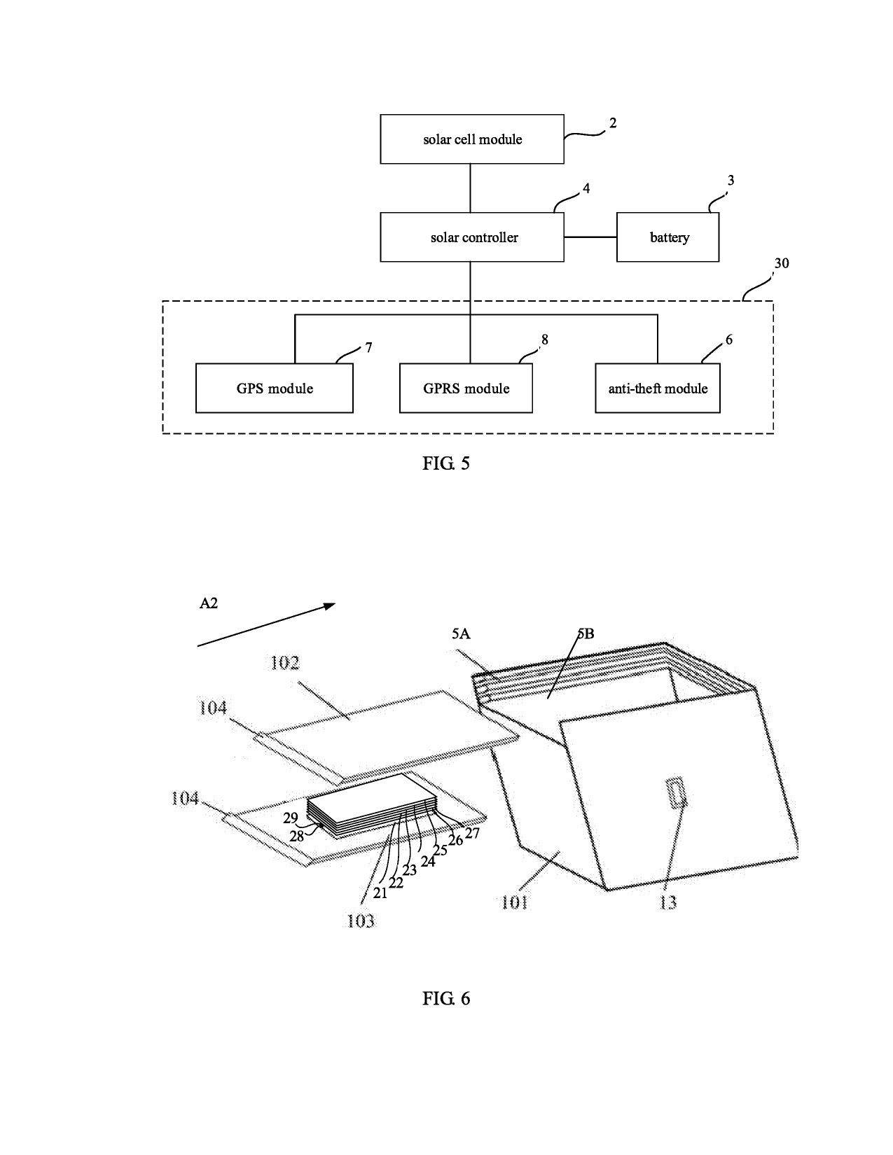

In one embodiment, as shown in FIG. 4 and FIG. 5, the function module 30 includes an anti-theft module 6. The anti-theft module 6 is used to output an alarm signal when the anti-theft module 6 detects loss of goods in the box body 1. The solar controller 4 is connected with the solar cell module 2, the battery 3 and the anti-theft module 6, respectively, and is used to output electrical energy converted by the solar cell module 2 to the battery 3 for storage. The solar controller 4 is further used to control the battery 3 to supply power to the anti-theft module 6. The solar cell module 2 is used for solar electrical energy generation, and charges the battery 3 through the solar controller 4. Then the battery 3 supplies power to the anti-theft module 6 through the solar controller 4, thereby realizing sustainable anti-theft alarm function for express goods. The solar controller 4 may adjust input voltage and current. When the battery 3 is fully charged, the solar controller 4 cuts off external power input for the battery 3. When the battery 3 is discharged excessively and the voltage is insufficient, the solar controller 4 may provide a prompt. The solar controller 4 may simultaneously adjust an output voltage and an output electric current of the battery 3, thereby enabling the output voltage and the output electric current to match power demands of each functional module and then enabling each functional module to work normally.

In one embodiment, in addition to the anti-theft module 6, the function module 30 further includes a GPS module 7 and a GPRS module 8. The battery 3 supplies power to the anti-theft module 6 through the solar controller 4, thereby realizing sustainable anti-theft alarm function for express goods. The solar controller 4 may adjust input voltage and current. When the battery 3 is fully charged, the solar controller 4 cuts off external power input for the battery 3. When the battery 3 is discharged excessively and the voltage is insufficient, the solar controller 4 may provide a prompt.

The battery 3 may further supply power to the GPS module 7 and the GPRS module 8 through the solar controller 4, thereby realizing real time satellite positioning monitoring function for express goods. The GPS module 7 is used for real time satellite positioning the packing box, and transmits current position information to an express company, a logistics company system platform or a target terminal through the GPRS module 8, thereby facilitating owners to inquire, master arrival time of goods and prepare for receiving the goods.

Optionally, as shown in FIG. 1, the anti-theft module 6 further includes a weight sensor 9. The weight sensor 9 is disposed at an inner lateral wall or a bottom wall of the box body 1. After the weight sensor 9 detects that goods in the box body 1 are removed away, the weight sensor 9 is used to send a reminder signal to the solar controller 4. Then, the solar controller 4 outputs a control signal to the GPRS module 8, so as to transmit the alarm signal to the express company, the logistics company system platform or the target terminal. When the goods are placed in the box body 1, the goods are placed on the weight sensor 9 and are fixed by means of a tension rope, etc., thereby preventing the goods from separating from the weight sensor 9 in transportation of the goods. When the goods are stolen, the weight sensor 9 transmits an alarm signal to solar controller 4. Then, the solar controller 4 outputs a control signal to the GPRS module 8, so as to transmit the alarm signal to the express company, the logistics company system platform or the target terminal.

Further, the weight sensor 9 is connected with the GPRS module 8. The weight sensor 9 is further used to, when the weight sensor 9 detects that the goods are removed away, send a reminder signal to the target terminal through the GPRS module 8, to inform that the express goods have been taken out and to remind alarm. Optionally, the solar controller 4 is further used to, when detecting that the battery's charge has dropped to a set value, output a control signal to the GPRS module 8, thereby controlling the GPRS module 8 to send a reminder signal to the target terminal.

Optionally, in one embodiment, the solar cell module 2 is a thin film component with its back plate being integrally formed with the power generation cover 103. The thin film component is light and soft, and may generate electricity under weak light. The thin film component may be disposed at an outer wall of the power generation cover 103, and may be integrally formed with the power generation cover 103 to enable the thin film component to be sturdy and durable while ensuring that the thin film component can be used for solar electrical energy generation. The thin film component may be disposed at an outer lateral side of the power generation cover 103, and may occupy more than 10% of an area of the outer lateral side of the power generation cover 103. The thin film component may be integrally formed with the outer lateral side of the power generation cover 103 by mean of laminating or welding. The outer lateral side is provided with an opening. An area of the opening is slightly greater than an area of a junction box of the thin film component. The junction box of the thin film component extends through the opening and into the case body 101.

The protection cover 102 and the power generation cover 103 may be connected with the case body 101 in a variety of connections modes such as hinged connection, clamping, bonding. In one embodiment, the protection cover 102 and the power generation cover 103 may be inserted in the case body 101.

As shown in FIG. 2, optionally, the case body 101 is provided with two stacked sliding grooves 5. The two sliding grooves 5 includes a first sliding groove 5A and a second sliding groove 5B below the first sliding groove 5A (when the box body 1 is at a position shown in FIG. 2). The protection cover 102 is in sliding engagement with the first sliding groove 5A. The power generation cover 103 is in sliding engagement with the second sliding groove 5B. The thin film component may be attached to the outer wall of the power generation cover 103. The protection cover 102 and the power generation cover 103 together define a double-layer cover, which makes the seal between the case body 101 and the cover tighter, and enhances strength and waterproofness of opening and closing positions between the case body 101 and the cover. In the embodiment shown in FIG. 1 and FIG. 2, the protection cover 102 and the power generation cover 103 may slide along a direction indicated by an arrow A1 in the first sliding groove 5A and the second sliding groove 5B, respectively.

Optionally, the case body 101 and the box cover 210 may be made by means of injection molding. The case body 101 may be made of polymer resin by mean of direct injection molding, compression molding or plastic molding. The resin of the polymer resin includes but not limited to, PP, PE, PVC, PA, PC, PC/ABS, ABS, AS, etc. The resin filler of the polymer resin includes but not limited to, talcum powder, calcium carbonate, barium sulfate, mica powder, glass fiber. The resin additive of the polymer resin includes but not limited to, anti-oxygen, release agent, toner, fire retardant and anti-UV stabilizer.

In the double-layer cover, the protection cover 102 is mounted to the outermost side of the case body 101, located in the first sliding groove 5A that is above the second sliding groove 5B, and tightly covers the case body 101. The protection cover 102 is transparent and has a light transmittance of light (400 nm-1100 nm wavelength) greater than or equal to 70%. Thus, the protection cover 102 can protect the power generation cover 103 while not affecting light transmission. The light transmittance of the protection cover 102 is reduced to less than 50% or the protection cover 102 is seriously deformed or damaged, the protection cover 102 may be replaced with a new one. The protection cover 102 may be made of transparent resin by mean of direct injection molding, compression molding or plastic molding. The transparent resin includes but not limited to, PET, PC, PMMA, PVC. An exposed surface of the protection cover 102 may be coated with a transparent hard coating layer, and may be frosted, thereby improving abrasion resistance and scratch resistance of the exposed surface. Materials of the hard coating layer include but not limited to, polyurethane acrylate, polyenoic acid esters and silicone acrylate.

The power generation cover 103 is below the protection cover 102 (when the box body 1 is at a position shown in FIG. 2). The power generation cover 103 slides in the second sliding groove 5B that is below the first sliding groove 5A, and tightly covers the case body 101. The solar cell module 2 is oriented towards an outside of the packing box with its back plate being a back side of the power generation cover 103. The back plate of the solar cell module 2 and the box body 1 are made of the same resin, and they may be made of polymer resin by mean of direct injection molding, compression molding or plastic molding. A hole 29 (as shown in FIG. 6) is defined in the back plate of the solar cell module 2 for extending a bus wire 28 (as shown in FIG. 6). The bus wire 28 is connected with the junction box. The junction box and the junction box are sealed by a sealant. A lead wire of the junction box is connected with a lead wire of the function module, thereby defining a conduction circuit. The solar cell module 2 and the power generation cover 103 are laminated together to form an integral cover. As shown in FIG. 6, the thin film component includes a back plate 21, a first adhesive film 22, a battery cell 23, a second adhesive film 24, a high-resistance water-vapor barrier layer 25, a third adhesive film 26 and a weather resistant layer 27, which are sequentially arranged in a direction away from the power generation cover 103.

In order to facilitate replacing the cover, as shown in FIG. 2, a handle 104 is provided at an end of each of the protection cover 102 and the power generation cover 103.

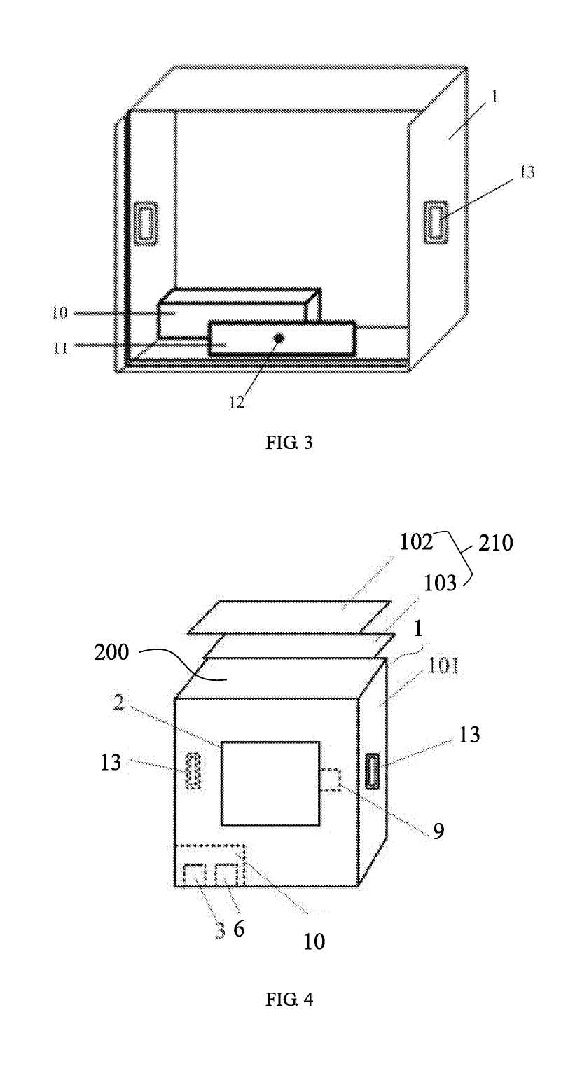

On basis of the above embodiment, as shown in FIG. 3, the packing box further includes an accommodation box 10 and a cap 11. The accommodation box 10 and the cap 11 are disposed within the box body 1. As shown in FIG. 1, the solar controller 4, the battery 3, the GPS module 7 and the GPRS module 8 may be disposed within the accommodation box 10. After the solar controller 4, the battery 3, the GPS module 7 and the GPRS module 8 are disposed within the accommodation box 10, the cap 11 may be mounted to the accommodation box 10 and covers the accommodation box 10, thereby fixing the solar controller 4, the battery 3, the GPS module 7 and the GPRS module 8 within the accommodation box 10. A through hole 12 is defined in the cap 11 for allowing wires extending therethrough. After the various function modules are fixed in the accommodation box 10, wires extend outside through the through hole 12. The presence of the accommodation box 10 may prevent the goods in the box body 1 from damaging the solar controller 4, the battery 3 and above function modules. Further, the presence of the accommodation box 10 may also prevent the solar controller 4, the battery 3 and above function modules from being damaged when the packing box is dropped during handling.

Further, handheld structures may be provided at two opposite sides of the box body 1. The handheld structures may be handles or projecting objects. In one embodiment, the handheld structures may be grooves 13 that are directly defined in the outer wall of the box body 1 through a simple processing procedure. The presence of the handheld structures facilitates holding the box body 1 by hand to carry the packing box.

FIG. 4 is a schematic diagram of a packing box according to some embodiments of the present disclosure. FIG. 5 is a control principle diagram of the packing box according to some embodiments of the present disclosure. The packing box shown in FIG. 4 and FIG. 5 is similar to the packing box shown in FIG. 1 to FIG. 3, the main difference between the two lies in that the solar cell module 2 of the packing box shown in FIG. 4 and FIG. 5 is disposed at an outer wall of the case body 101.

Optionally, in one embodiment, the solar cell module 2 is a thin film component and is attached to the outer wall of the case body 101. The thin film component is light and soft, and may generate electricity under weak light. The thin film component may be disposed at the outer wall of the case body 101, and may be integrally formed with the case body 101 to enable the thin film component to be sturdy and durable while ensuring that the thin film component can be used for solar electrical energy generation. The thin film component may be disposed at an outer lateral side of the case body 101, and may occupy more than 10% of an area of the outer lateral side of the case body 101. The thin film component may be integrally formed with the outer lateral side of the case body 101 by mean of laminating or welding. The outer lateral side is provided with an opening. An area of the opening is slightly greater than an area of a junction box of the thin film component. The junction box of the thin film component extends through the opening and into the box body 1.

In the packing box provided in some embodiments of the present disclosure, the presence of the solar cell module can convert solar energy into electrical energy, thereby realizing sustainable energy supply to the functional module. Meanwhile, when the function module includes the anti-theft module, the solar cell module converts solar energy into electrical energy and supplies the electrical energy to the anti-theft module, thereby enabling the packing box to have an anti-theft function and realizing anti-theft function via sustainable energy supply.

As understood by those skilled in the art, the various function modules may be controlled by the solar controller of the solar cell module, or may be controlled by a separated controller, which are not specifically limited.

The above are merely the optional embodiments of the present disclosure and shall not be used to limit the scope of the present disclosure. It should be noted that, a person skilled in the art may make improvements and modifications without departing from the principle of the present disclosure, and these improvements and modifications shall also fall within the scope of the present disclosure.

What is claimed is:

1. A packing box comprising:
a box body;
a solar cell module ;
a battery disposed on the box body;
a function module disposed on the box body; and
a solar controller;
wherein the solar controller is connected with the solar cell module, the battery and the function module, respectively, and is configured to output electrical energy converted by the solar cell module to the battery and control the battery to supply power to the function module;
wherein the box body comprises a case body with an end provided with an opening, and a box cover that covers and seals the opening; the box cover comprises a power generation cover and a protection cover; the protection cover is located at an outside of the power generation cover and is transparent; and the solar cell module is disposed at the power generation cover.

2. The packing box of claim 1, wherein the protection cover and the power generation cover are inserted in the case body.

3. The packing box of claim 2, wherein the case body is provided with a first sliding groove and a second sliding groove below the first sliding groove; the protection cover is in sliding engagement with the first sliding groove; and the power generation cover is in sliding engagement with the second sliding groove.

4. The packing box of claim 1, wherein a handle is provided at an end of each of the protection cover and the power generation cover.

5. The packing box of claim 1, wherein the function module comprises an anti-theft module; the anti-theft module is configured to output an alarm signal when the anti-theft module detects loss of goods in the box body.

6. The packing box of claim 5, wherein the anti-theft module comprises a weight sensor; the weight sensor is disposed at an inner lateral wall or a bottom wall of the box body; the weight sensor is configured to, after the weight sensor detects that the goods in the box body are removed away, send a reminder signal to the solar controller.

7. The packing box of claim 6, wherein the function module further comprises a global positioning system (GPS) module and a general packet radio service (GPRS) module; the GPS module and the GPRS module are connected with the solar controller and located within the box body.

8. The packing box of claim 7, wherein the weight sensor is connected with the GPRS module; the weight sensor is further configured to, when the weight sensor detects that the goods are removed away, send a reminder signal to a target terminal through the GPRS module.

9. The packing box of claim 8, further comprising an accommodation box;
wherein the solar controller, the battery, the GPS module and the GPRS module are disposed within the accommodation box; and a through hole is arranged on the accommodation box for allowing wires to extend through.

10. The packing box of claim 7, wherein the solar controller is further configured to, when detecting that the battery's charge has dropped to a set value, output a control signal to the GPRS module, thereby controlling the GPRS module to send a reminder signal to a target terminal.

11. The packing box of claim 1, wherein at least one lateral wall of the case body is provided with the solar cell module; the solar cell module disposed at the power generation cover and the solar cell module disposed at the case body are thin film components.

12. The packing box of claim 11, wherein each of the thin film components occupies more than 10% of an area of a surface where each of the thin film components is disposed.

13. The packing box of claim 1, wherein the solar cell module comprises a thin film component that is attached to the power generation cover; the thin film component comprises a back plate, a first adhesive film, a solar cell, a second adhesive film, a high-resistance water-vapor barrier layer, a third adhesive film and a weather resistant layer, which are sequentially arranged in a direction away from the power generation cover.

14. The packing box of claim 13, wherein a hole is arranged on the back plate for extending a bus wire.

15. The packing box of claim 1, wherein handheld structures are provided at two opposite sides of the box body.
